(19) United States
(12) Patent Application Publication
(10) Pub. No.: US 2004/0155975 A1
(43) Pub. Date: Aug. 12, 2004

(54) 3-D imaging system

(76) Inventors: Douglas P. Hart, Charlestown, MA (US); Jan Lammerding, Cambridge, MA (US); Janos Rohaly, Bedford, MA (US)

Correspondence Address: LAHIVE & COCKFIELD, LLP., 28 STATE STREET, BOSTON, MA, 02109, US

(21) Appl. No.: 10/664,412

(22) Filed: Sep. 17, 2003

Related U.S. Application Data
(60) Provisional application No. 60/411,561, filed on Sep. 17, 2002.

(51) Int. Cl. H04N 5/225

(52) U.S. Cl. 348/335

(57) ABSTRACT

An active three-dimensional imaging system for optical apparatus includes a relay lens subsystem with an off-axis rotating aperture placed between an imaging or objective lens and an image recording device such as a CCD camera. According to another aspect, the imaging system can include an off-axis rotating aperture located between field and aperture diaphragms of an illumination subsystem. The rotating aperture allows adjustable non-equilateral spacing between images of out-of-focus object points to achieve higher spatial resolution, increased sensitivity and higher sub-pixel displacement accuracy than other systems.

### RELATED APPLICATION

This application claims the benefit of U.S. Provisional Application No. 60/411,561, filed on Sep. 17, 2002. The entire teachings of the above application are incorporated herein by reference.

### BACKGROUND

Multi hole off-axis apertures have been widely used in testing optical elements for nearly one hundred years. A mask with two off-axis apertures can also be used to correct or quantify defocusing and this technique, invented by the Jesuit astronomer Christoph Scheiner (1573-1650), has been used to focus telescopes for nearly 400 years. Others have used such a double aperture mask to create depth related image disparities in single exposed images in order to guide robots in three-dimensional object space. More recently, a three-aperture equivalent of the Hartmann mask has been applied to track particles in three-dimensions. These techniques derive quantitative depth information by sampling the optical wavefront according to the aperture positions. Since the mask with the off-axis apertures is stationary, such imaging systems are passive and their limitations are defined by the fixed baseline they apply.

### SUMMARY

The present invention is directed to active three-dimensional imaging systems adapted for two-dimensional optical apparatus. According to one embodiment, a three-dimensional imaging system can include a relay lens subsystem with an off-axis rotating aperture placed at an exit pupil between an imaging or objective lens and an image recording device such as a CCD camera. According to an aspect, the relay lens subsystem includes a first lens group and a second lens group spaced apart with the aperture element disposed between the lens groups. The first lens group includes at least one field lens and the second lens group includes at least one focusing lens.

According to another embodiment, the imaging system can include an off-axis rotating aperture located between field and aperture diaphragms of an illumination subsystem. In one embodiment, the rotating aperture is placed at the aperture diaphragm. According to an aspect, an optical apparatus is coupled to receive illumination from the illumination subsystem along an illumination path and an image recording device is coupled to the optical apparatus along the imaging path. In another aspect, the illumination subsystem further includes a field diaphragm, an aperture diaphragm and a condenser spaced apart along the optical axis with the aperture element disposed between the field diaphragm and the aperture diaphragm.

The rotating aperture allows adjustable non-equilateral spacing between images of out-of-focus object points to achieve higher spatial resolution, increased sensitivity and higher sub-pixel displacement accuracy than other systems. The three-dimensional imaging system may include rotation means for rotating the aperture element about the optical axis.

The three-dimensional imaging system can be adapted with two-dimensional optical apparatus such as a microscope, telescope, endoscope or borescope. The imaging system can include an image processor for processing acquired images.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic block diagram illustrating principles of a three-dimensional imaging system in accordance with one aspect of the present invention.

FIG. 2A is a diagram showing details of a first embodiment of the system of FIG. 1.

FIG. 2B is a diagram showing details of a second embodiment of the system of FIG. 1.

FIG. 3 illustrates a rotating offset aperture for use in the system of FIG. 1.

FIG. 4 schematically illustrates the principle of the rotating offset aperture encoding depth information into circular image disparity.

FIG. 5 is a schematic block diagram illustrating principles of a three-dimensional imaging system in accordance with another aspect of the present invention.

FIG. 6A is a diagram showing an illumination system.

FIG. 6B is a diagram showing an illumination subsystem with an off-axis aperture element in a first position of the system of FIG. 5.

FIG. 6C is a diagram showing an illumination subsystem with an off-axis aperture element in a second position of the system of FIG. 5.

FIG. 7A illustrates imaging of an in-focus object point at two positions of a rotating aperture element placed in the illumination path of a microscope.

FIG. 7B illustrates imaging of an out-of-focus object point at two positions of a rotating off-axis aperture element placed in the illumination path of a microscope.

FIG. 8 is a schematic cross-sectional diagram of a module.

FIG. 9 is a double exposure image of a suspension of magnetic beads with a microscope having a rotating off-axis aperture element in the illumination path.

### DETAILED DESCRIPTION

The present approach provides an active three-dimensional imaging system that includes an off-axis rotating aperture element placed either in the illumination path or in the imaging path of an optical apparatus. The use of a rotating off-axis aperture element for three-dimensional imaging is disclosed in U.S. application Ser. No. 09/616,606, filed Jul. 14, 2000, and entitled “Method and Apparatus for High Resolution, Ultra Fast 3-D Imaging,” the entire contents of which are incorporated herein by reference.

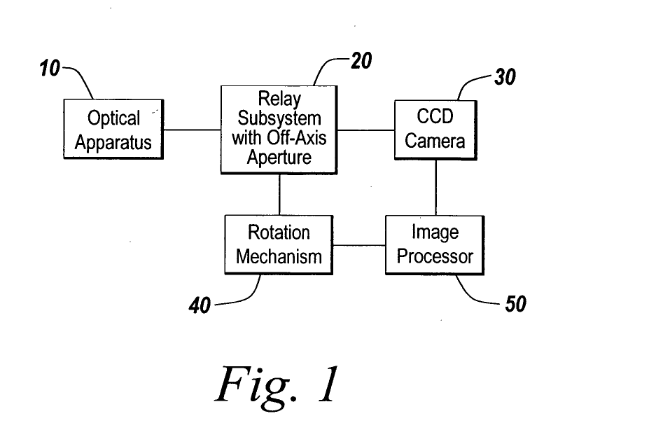

FIG. 1 illustrates general principles of a three-dimensional imaging system that disposes an off-axis aperture in the imaging path. The system includes an optical apparatus 10, a relay subsystem 20 with an off-axis aperture element and a CCD camera 30 disposed in optical alignment along an optical axis. The imaging system further includes a rotation mechanism 40 coupled to the relay subsystem 20 and an image processor 50 coupled to the CCD camera 30.

The optical apparatus 10 can be a microscope, telescope, endoscope, borescope or other optical scope apparatus. The rotation mechanism 40 can be any type of electromechanical motor apparatus that can provide rotation of the off-axis aperture element. The image processor 50 can be implemented in a programmed general purpose computer. In other embodiments, the image processor 50 can be implemented in nonprogrammable hardware designed specifically to perform the image processing functions disclosed herein. The image processor can provide feedback to the rotation mechanism for control.

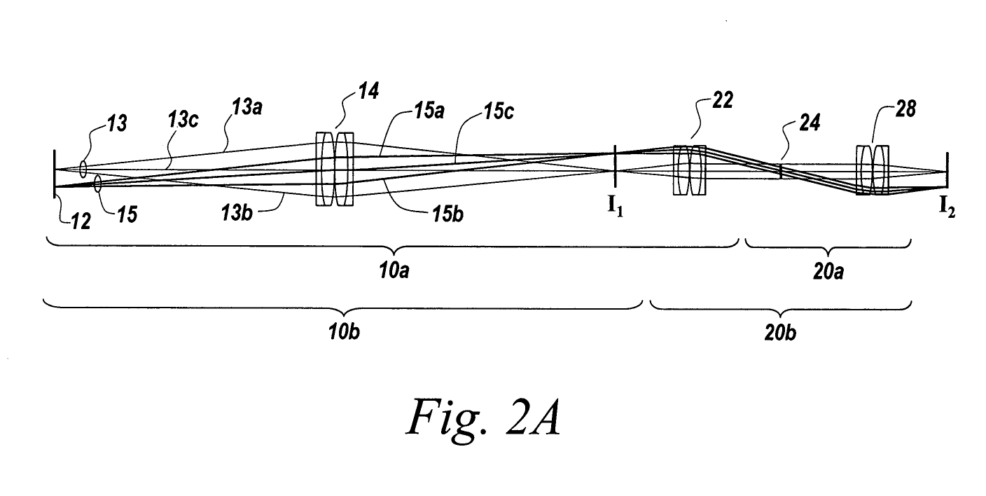

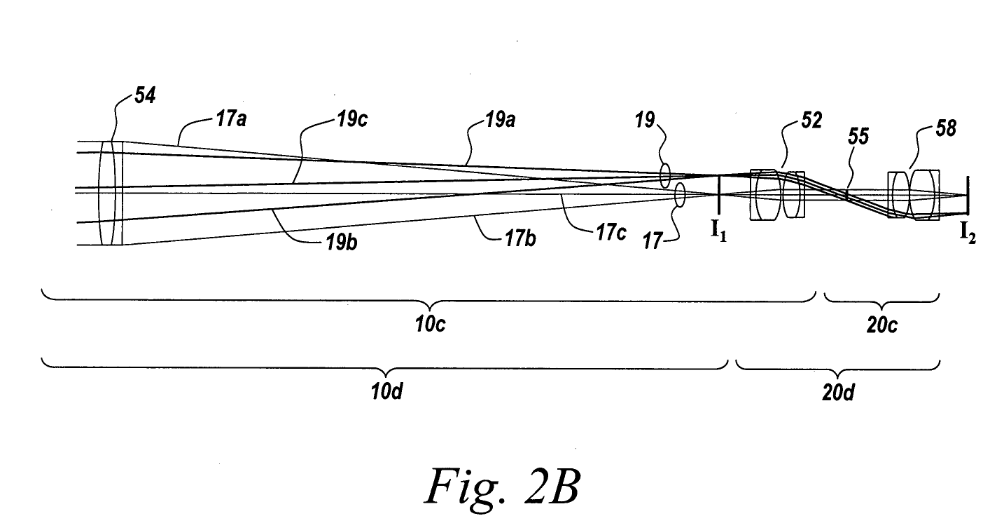

FIG. 2A illustrates details of a first embodiment of the optical apparatus 10 and relay subsystem 20 of FIG. 1. The optical apparatus can be, for example, a microscope or endoscope. The optical apparatus denoted 10b is shown as including a specimen 12 and an objective lens group 14 that provides an image at image plane I₁. The relay subsystem 20b includes a field lens group 22 and a focusing or relay lens group 28 with an aperture element 24 disposed between the lens groups and aligned along the optical axis and placed at the exit pupil. The relay subsystem transfers the image at virtual image plane I₁ to image plane I₂ corresponding to a CCD element of CCD camera 30 (FIG. 1). The magnification of the relay subsystem is on the order of M≈1. The aperture element can also be referred to as a wavefront sampling aperture element.

In embodiments in which the optical apparatus includes an eyepiece as denoted for the optical apparatus 10a, the eyepiece serves the function of the field lens group and in that case the relay lens system may not include a field lens group as denoted 20a.

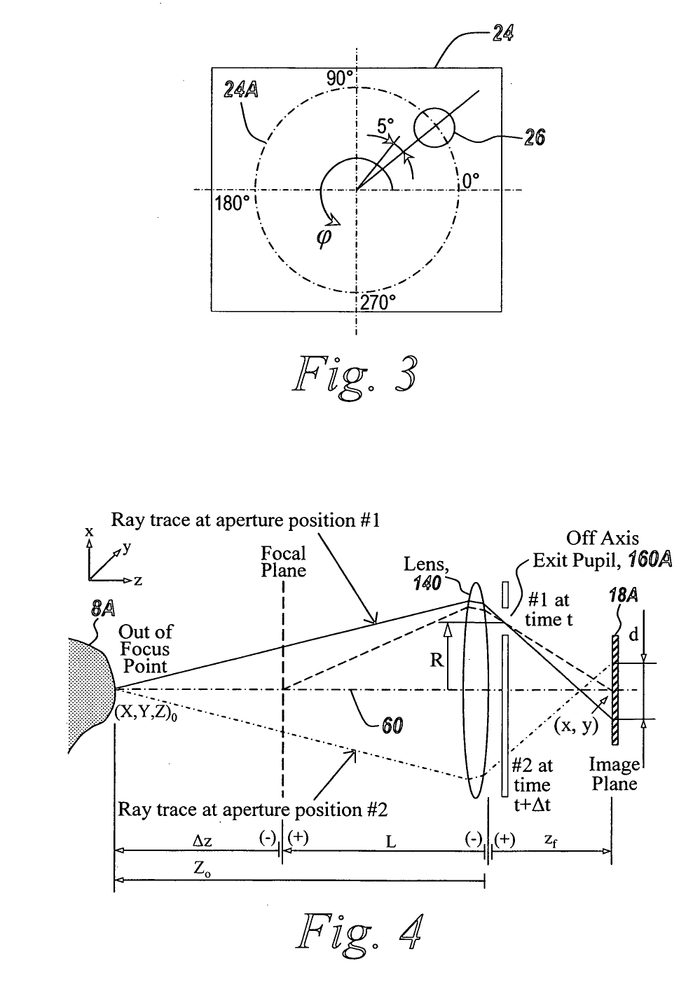

As shown in FIG. 3, the aperture element 24 includes an off-axis opening 26. The off-axis opening 26 samples the blurred image of any out-of-focus point that results in a circular movement as the aperture rotates along a circle 24A around the optical axis through an angle denoted φ. The circular movement of the aperture encodes depth information into circular image disparity. The circle diameter represents the out-of-plane (z) and the center gives the in plane (x,y) coordinates of an object point relative to the reference (focal) plane. The phase difference between the movement of the aperture and an image spot indicates whether the point is behind or in front of the focal plane. The adjustable non-equilateral spacing between images permits higher spatial resolution, increased sensitivity and higher sub-pixel displacement accuracy in resolving object positions in the third (z) dimension.

Referring again to FIG. 2A, there are shown axial and chief ray bundles 13 and 15, respectively. The axial ray bundle 13 includes ray traces 13a, 13b, 13c and the chief ray bundle 15 includes ray traces 15a, 15b, 15c. With the aperture element opening 26 positioned at 90 degrees (FIG. 3), the ray traces 13b and 15b appear at the image plane 12. Likewise, with the aperture element opening 26 positioned at 270 degrees, the ray traces 13a and 15a appear at the image plane I₂.

FIG. 2B illustrates a second embodiment of the optical apparatus 10 and relay subsystem 20 of FIG. 1. The optical apparatus can be, for example, a telescope. The optical apparatus denoted 10d is shown as including an objective lens group 54 that provides an image at image plane I₁. The relay subsystem 20d includes a field lens group 52 and a focusing or relay lens group 58 with an aperture element 55 (similar to aperture element 24 of FIGS. 2A and 3) disposed between the lens groups and aligned along the optical axis. The relay subsystem transfers the image at virtual image plane I₁ to image plane I₂ corresponding to a CCD element of CCD camera 30 (FIG. 1). The magnification of the relay subsystem is on the order of M≈1.

In embodiments in which the optical apparatus includes an eyepiece as denoted for the optical apparatus 10c, the eyepiece serves the function of the field lens group and in that case the relay lens system may not include a field lens group as denoted 20c.

There are shown axial and chief ray bundles 17 and 19, respectively. The axial ray bundle 17 includes ray traces 17a, 17b, 17c and the chief ray bundle 19 includes ray traces 19a, 19b, 19c. With the aperture element opening positioned at 90 degrees (FIG. 3), the ray traces 17b and 19b appear at the image plane I₂. Likewise, with the aperture element opening positioned at 270 degrees, the ray traces 17a and 19a appear at the image plane I₂.

To understand the theory employed in the present imaging systems, FIG. 4 illustrates the concept of measuring out-of-plane coordinates of object points by sampling the optical wavefront, with an off-axis rotating aperture element, and measuring the defocus blur diameter. The system shown for illustrating the concept includes a lens 140, a rotating aperture element 160 and an image plane 18A. The single aperture avoids overlapping of images from different object regions hence it increases spatial resolution. The rotating aperture allows taking images at several aperture positions and this can be interpreted as having several cameras with different viewpoints, which generally increases measurement sensitivity. The actively controlled aperture movement allows adjustable image disparity to increase accuracy of displacement detection.

The aperture movement makes it possible to record on a CCD element a single exposed image at different aperture locations. In one approach to processing of the image, localized cross-correlation can be applied to reveal image disparity between image frames. There are several advantages to using cross-correlation rather than auto-correlation: reduced noise level, detection of zero displacement (in-focus points) and the absence of directional ambiguity, all of which are major problems of auto-correlation based processing. These advantages make higher signal-to-noise ratio, higher spatial and depth resolution, and lower uncertainty feasible. It should be understood that other processing approaches can be used that are not correlation based.

As can be seen in FIG. 4, at least two image recordings on the image plane 18A at different angles of rotation of the aperture 160 are used to generate the measured displacement for target object 8A. The separate images are captured successively as the aperture rotates to position #1 at time t and position #2 at time t+Δt. Note that Δt is generally negligible in relation to possible movement of the target object 8A. The recorded images can be processed using spatio-temporal processing.

The rotation center of the image gives the proper in-plane object coordinates,

$$\begin{matrix}{X}_{0} = \frac{- x {Z}_{0} ( L - f )}{fL} & ( 1 a ) \\ {Y}_{0} = \frac{- y {Z}_{0} ( L - f )}{fL} & ( 1 b )\end{matrix}$$

where X₀,Y₀ are the in-plane object coordinates, f is the focal length of the lens objective, L is the depth of in-focus object points (focal plane), R is the radius of the circle along which the off-axis pupil is rotating, and d is the diameter of a circle along which the relevant out-of-focus point is moving on the image plane 18A as the aperture is rotated. The magnitude of the pattern movement represents the depth information (Z₀) measured from the lens plane. Z₀ can be evaluated from two Snell's lens laws for in-focus and out-of-focus object points and by using similar triangles at the image side,

$${Z}_{0} = \frac{1}{L} + \frac{d ( L - f )}{2 RfL} \qquad ( 1 c )$$

The signal-to-noise ratio, relative error, and accuracy of detecting image pattern movement by image flow processing is influenced by the magnitude of the displacement vector being measured. For example, there is a trade-off between maximum detectable disparity and spatial resolution. This influence can be reduced and hence the dynamic range of displacement detection can be significantly improved by taking more than two images in non-equilateral aperture spacing. In order to remove possible ambiguity of image center detection, the rotation between the first and the third image is preferably 180 degrees while the intermediate recording can be adjusted according to the actual object depth.

With the imaging system as described with respect to FIGS. 1, 2A and 2B, image correlation techniques can be used by the image processor 50 (FIG. 1) to provide ultra fast and super high resolution image processing as described in the above-referenced application Ser. No. 09/616,606. For example, two image frames can be acquired. In particular, the aperture element is rotated such that the opening or off-axis aperture 26 (FIG. 3) is at a first position offset from the optical axis. A first image frame is captured using the aperture at the first position. Likewise, a second image frame is captured with the aperture rotated through an angle such that the opening or exit pupil is at a second offset position. Once the frames are captured, the image processor 50 (FIG. 1) can perform several techniques to correlate the information contained in the image frames. These techniques include sparse array cross-correlation, recursive correlation, correlation error correction and sub-pixel resolution processing. The sparse array image correlation approach is disclosed in U.S. Pat. No. 5,850,485 issued Dec. 15, 1998, the entire contents of which are incorporated herein by reference.

The advantage of the imaging system described above (FIGS. 1, 2A and 2B) is its simplicity; however, sampling the defocus spot by an off-axis rotating aperture in the imaging path inherently has its own limitations. The most important is that it requires stepping down the aperture, which reduces optical resolution and requires stronger illumination. Lens aberration related systematic bias in the created image disparity also needs to be considered.

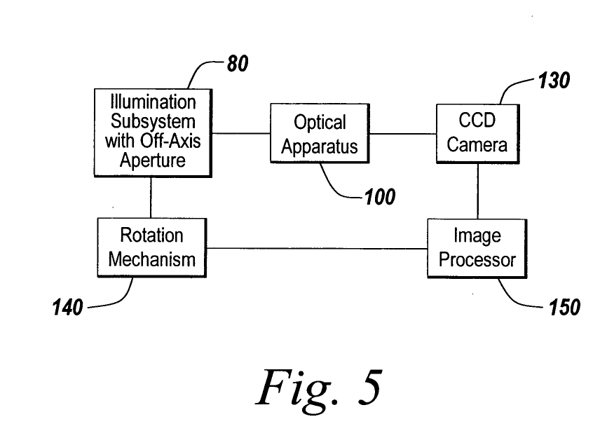

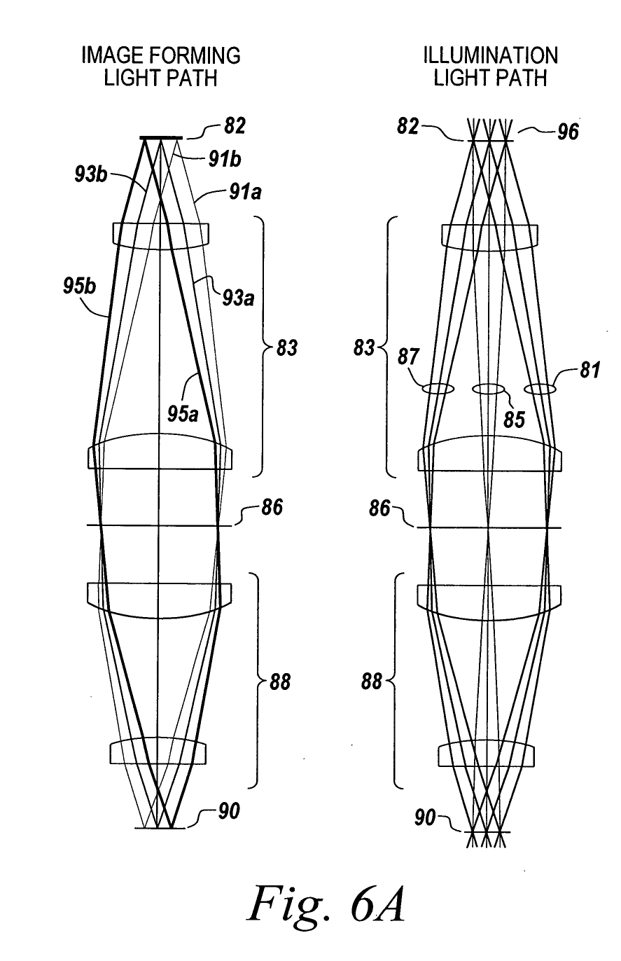

These barriers can be overcome by placing the off-axis rotating aperture in the illumination path. FIG. 5 generally illustrates such an imaging system that includes an illumination subsystem 80 having an off-axis aperture, optical apparatus 100, and CCD camera 130. The imaging system also includes a rotation mechanism 140 and a image processor 150.

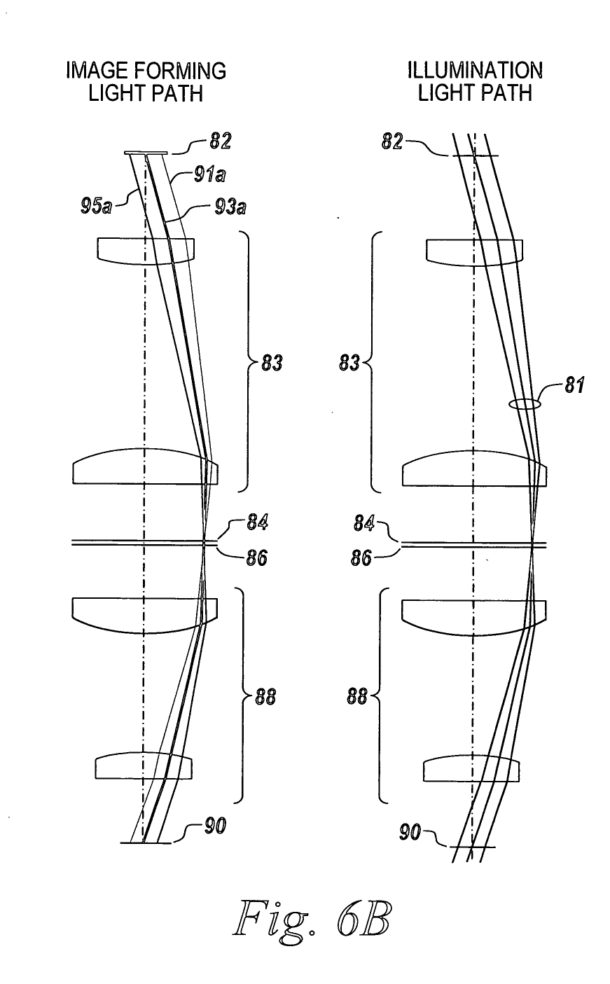

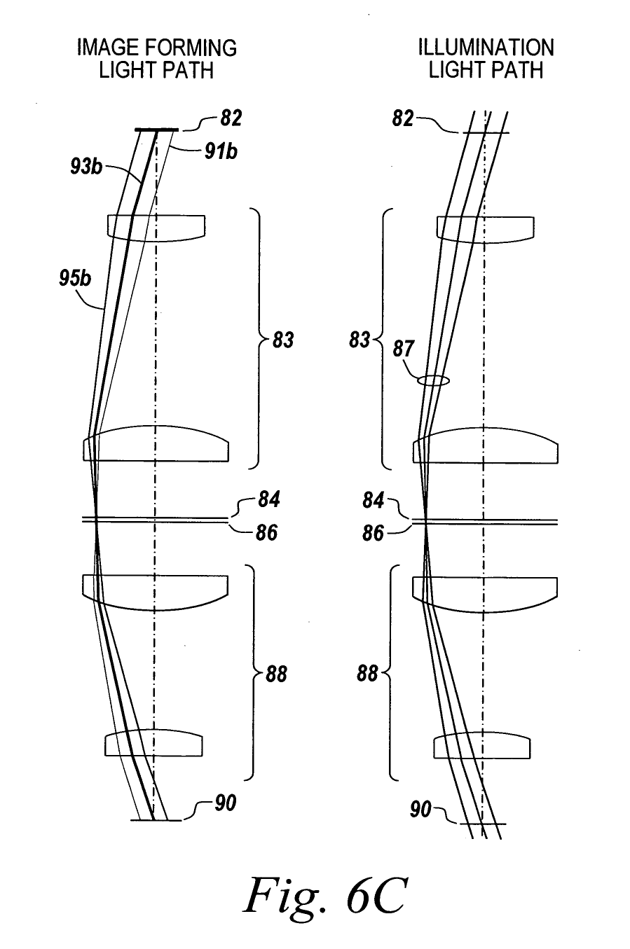

FIG. 6A illustrates an illumination subsystem of a Köhler illumination configuration that includes field diaphragm 82, field lens group 83, aperture diaphragm 86 and condenser 88. The right side illustrates the illumination light path and the left side illustrates the image forming path. Illumination 96 ray traces include bundles 81, 85 and 87 from an illumination source (not shown) that illuminate specimen 90. In the image forming path, ray bundles 91a, 91b; 93a, 93b; 95a, 95b correspond to respective points on the specimen 90.

FIGS. 6B and 6C illustrate details of an embodiment of the illumination subsystem 80 that incorporates an off-axis rotating aperture element 84. In particular, the aperture element 84 is disposed between the field and the aperture diaphragms, here shown as being positioned in close proximity to the aperture diaphragm 86. The use of the off-axis aperture element creates oblique illumination. In FIG. 6B, with the aperture element in a first position (e.g., 90 degrees—FIG. 3), ray bundle 81 passes through the off-axis opening of the aperture element to the specimen 90 in the illumination light path. In the image forming path, ray traces 91a, 93a, 95a are the corresponding ray traces that are selected with this first position. Likewise, in FIG. 6C, with the aperture element in a second position (e.g., 270 degrees—FIG. 3) ray bundle 87 passes through the off-axis opening of the aperture element in the illumination path and ray traces 91b, 93b, 95b are selected in the image forming path.

The aperture element can be rotated by means of the rotation mechanism 140 (FIG. 5) which may be of the general type described above for the rotation mechanism 40 (FIG. 1).

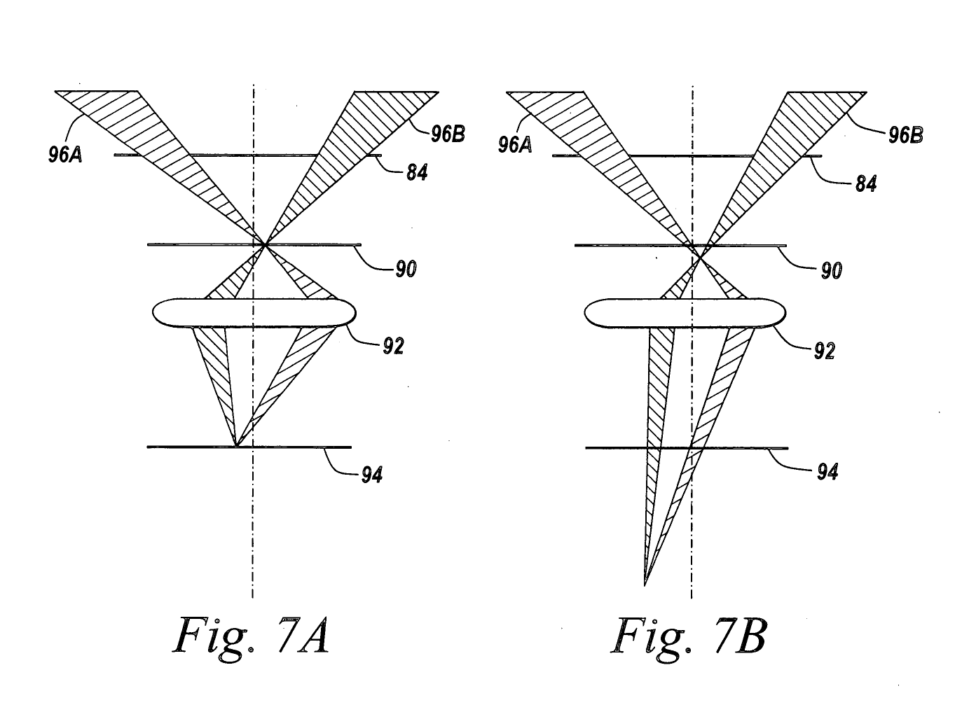

An in-focus object point at two positions of the rotating aperture placed in the illumination path is shown in FIG. 7A with respective oblique illumination light 96A, 96B. Movement of the off-axis rotating aperture results in movement of all out-of-focus image points, as schematically illustrated in FIG. 7B. Although the applied off-axis rotating aperture gives weaker illumination intensity, and reduces the specimen size that can be imaged, the system is free of all resolution and aberration related limitations. This approach is also preferred if the objective has very long depth-of-focus, since this creates very small image disparities limiting the sensitivity of depth measurements.

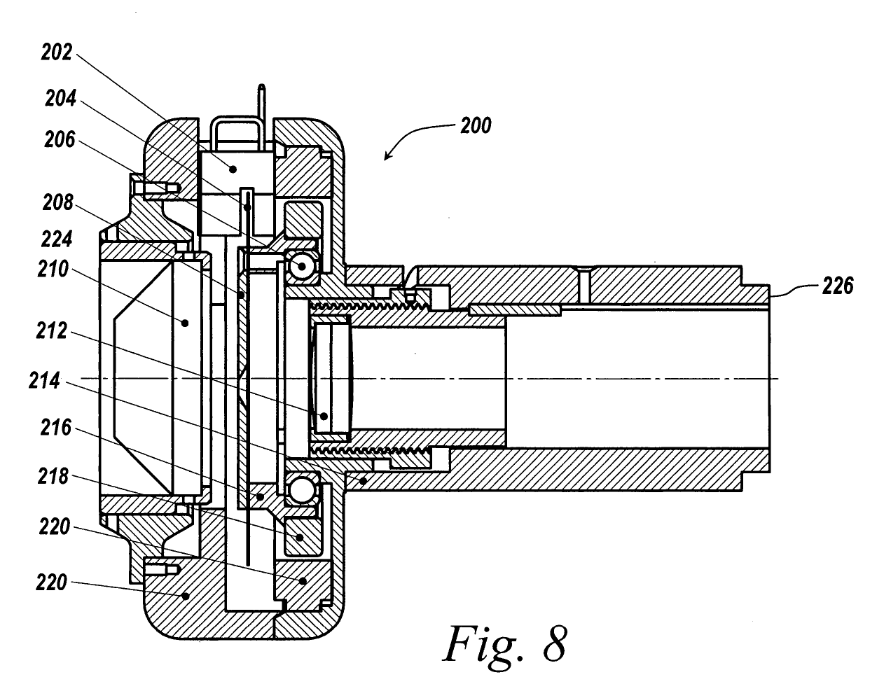

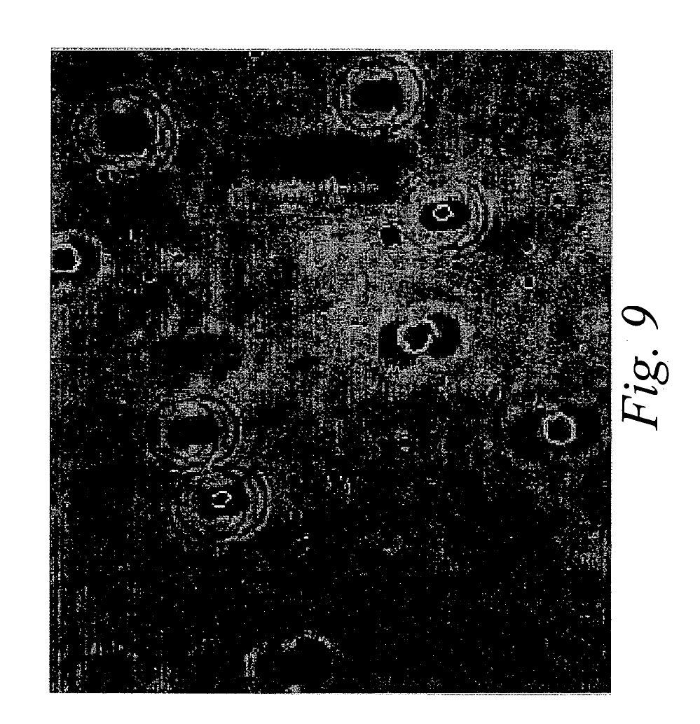

FIG. 8 is a cross-sectional diagram illustrating an embodiment of a module 200 for coupling between an optical apparatus at end 224 and an image recording device such as a CCD camera at end 226. The module includes a focusing or relay lens 212 aligned with eyecup (microscope or endoscope) 210. In embodiments for use with optical apparatus that do not have an eyepiece, the eyecup can be replaced with a field lens. An off-axis rotating aperture element 208 is positioned between the relay lens 212 and the eyecup 210 in aperture housing 222. The aperture housing 222 with bearing 206 is coupled to a C-mount housing 214. A brushless DC-motor including rotor elements 216, 218 and stator 220 is operable to rotate the aperture element 208. Rotation control is achieved through means of encoder disk 204 and encoder pickup 202.

Numerous imaging systems currently being used for medical and research applications can be readily adapted with the three-dimensional apparatus of the present approach to provide three-dimensional quantitative measurement. In particular, microscopes can be adapted into 3-D imaging devices using a module that encompasses either the relay subsystem or the illumination subsystem featuring off-axis aperture element described herein. Such microscopes adapted in this manner can fill the gap between simple and lower accuracy methods such as stereo microscopy and more sophisticated systems such as confocal microscopy.

In one particular example applying the present approach to magnetic bead microrheometry, a light microscope with an off-axis rotating aperture in the illumination path was used to image a suspension of magnetic beads, and to measure both the in-plane and out-of-plane position coordinates. Microscopic paramagnetic beads are attached to the cell membrane or embedded in the cytoskeleton and manipulated by magnetic tweezers. The bead displacement and cellular responses are monitored in three-dimensions to study mechanical properties and mechanotransduction events in single live cells. The sparsely distributed magnetic beads were imaged along the full rotation of the off-axis aperture, and their movements were tracked through the image frames.

FIG. 9 shows a preliminary result of this measurement. Two images from the recorded sequence are shown overlapped, indicating the depth related image disparity of the beads. The image is a double exposure of the suspension of 4.5 μm magnetic beads imaged through a 63× objective. The off-axis aperture in the illumination path of the microscope was rotated by 180 degrees between exposures. The circles on the image give an idea of the trajectories of the beads at full aperture rotation. They do not look closed because the focus of the microscope was slightly changed during image recording; this resulted in changing image disparities depending on the distance of the object points measured from the actual focal plane.

The three-dimensional apparatus of the present approach can also be adapted for use with standard endoscopes to allow surgeons to not only see tissue structures in two dimensions, but also to quantify their size and exact three-dimensional shape with high spatial resolution reconstructed images in real time and without needing to constantly move the endoscope tip. Other adaptations may include borescopes and telescopes.

While this invention has been particularly shown and described with references to preferred embodiments thereof, it will be understood by those skilled in the art that various changes in form and details may be made therein without departing from the scope of the invention encompassed by the appended claims.

What is claimed is:

1. A 3-D imaging system comprising:
an optical apparatus having an objective lens;
an image recording device; and
a relay subsystem coupled between the objective lens and the image recording device along an optical axis, the relay subsystem having an aperture element that includes an opening offset from the optical axis placed at the exit pupil.

2. The 3-D imaging system of claim 1 further comprising rotation means for rotating the aperture element about the optical axis.

3. The 3-D imaging system of claim 1 wherein the relay subsystem further includes a first lens group and a second lens group spaced apart with the aperture element disposed therebetween.

4. The 3-D imaging system of claim 3 wherein the first lens group includes at least one field lens and the second lens group includes at least one focusing lens.

5. The 3-D imaging system of claim 1 wherein the relay subsystem further includes a focusing lens spaced apart from the aperture element along the optical axis.

6. The 3-D imaging system of claim 1 wherein the optical apparatus comprises a microscope.

7. The 3-D imaging system of claim 1 wherein the optical apparatus comprises a telescope.

8. The 3-D imaging system of claim 1 wherein the optical apparatus comprises an endoscope.

9. The 3-D imaging system of claim 1 wherein the optical apparatus comprises a borescope.

10. The 3-D imaging system of claim 1 wherein the image recording device is a CCD camera.

11. The 3-D imaging system of claim 1 further comprising a image processor for processing images acquired by the image recording device.

12. A 3-D imaging system comprising:
an illumination subsystem having an aperture element with an opening offset from an optical axis;
an optical apparatus having an illumination path and an imaging path, the optical apparatus coupled to receive illumination from the illumination subsystem along the illumination path; and
an image recording device coupled to the optical apparatus along the imaging path.

13. The 3-D imaging system of claim 12 further comprising rotation means for rotating the aperture element about the optical axis.

14. The 3-D imaging system of claim 12 wherein the illumination subsystem further includes a field diaphragm, an aperture diaphragm and a condenser spaced apart along the optical axis with the aperture element disposed between the field diaphragm and the aperture diaphragm.

15. The 3-D imaging system of claim 12 wherein the optical apparatus comprises a microscope.

16. The 3-D imaging system of claim 12 wherein the image recording device is a CCD camera.

17. The 3-D imaging system of claim 12 further comprising a image processor for processing images acquired by the image recording device.

18. A module for coupling between an optical apparatus and an image recording device, the module comprising:
a lens group;
an aperture element spaced apart from the lens group along an optical axis, the aperture element including an opening offset from the optical axis.

19. The module of claim 18 wherein the lens group includes at least one focusing lens.

20. The module of claim 19 further comprising a field lens disposed along the optical axis with the aperture element disposed between the field lens and the focusing lens.

21. The module of claim 18 further comprising rotation means for rotating the aperture element about the optical axis.

22. The module of claim 21 further comprising a housing that encloses the lens group, the aperture element and the rotation means.

23. The module of claim 22 wherein the lens group includes at least one focusing lens and further comprising a field lens disposed along the optical axis with the aperture element disposed between the field lens and the focusing lens.
